(19) United States
(12) Patent Application Publication
(10) Pub. No.: US 2023/0268554 A1
(43) Pub. Date: Aug. 24, 2023

(54) ADDITIVE MIXTURES FOR NON-AQUEOUS BATTERY ELECTROLYTES

(71) Applicant: Novonix Battery Technology Solutions Inc., Dartmouth (CA)

(72) Inventors: Stephen Laurence Glazier, Halifax (CA); Yadong Huang, Halifax (CA); John Christopher Burns, Halifax (CA); Mark Albert McArthur, Halifax (CA); Kenneth George Broom, Head of St. Margaret's Bay (CA)

(21) Appl. No.: 18/311,204

(22) Filed: May 2, 2023

Related U.S. Application Data
(63) Continuation of application No. PCT/US2021/055569, filed on Oct. 19, 2021.
(60) Provisional application No. 63/109,575, filed on Nov. 4, 2020.

(51) Int. Cl. H01M 10/0567; H01M 10/0569; H01M 10/0525; H01M 4/525; H01M 4/505; H01M 4/131

(52) U.S. Cl. CPC H01M 10/0567; H01M 10/0569; H01M 10/0525; H01M 4/525; H01M 4/505; H01M 4/131; H01M 2300/004

(57) ABSTRACT

Additive mixtures for nonaqueous battery electrolytes have been discovered that provide for improved performance, and particularly for improved lifetime (cycle life and stability) in high voltage, rechargeable lithium ion batteries. The battery electrolytes comprise less than 10% by weight of an additive mixture comprising an additive solvent, a sulfur containing compound, and lithium difluorophosphate.

### TECHNICAL FIELD

The present disclosure pertains to additive mixtures for use in battery electrolytes, and particularly in electrolytes of high voltage, rechargeable lithium ion batteries.

### BACKGROUND

The development of rechargeable high energy density batteries, such as lithium ion (Li-ion) batteries, is of great technological importance. Conventional Li-ion batteries have been in substantial use in numerous commercial applications now for many years. Such batteries employ one or more lithium insertion compounds for each of the cathode and anode electrodes. During discharge of the battery, lithium is extracted from the anode material while lithium is inserted into the cathode material. During charge, the process is reversed. The voltage difference between the two electrodes as lithium is removed from one electrode and inserted in the other electrode determines the overall voltage of the battery. The number of times this can be accomplished without significant loss of lithium to parasitic reactions or without other failures limits the lifetime of such batteries.

Typically, in Li-ion batteries, one or more lithium transition metal oxides are employed as cathode materials while one or more carbonaceous materials, e.g. graphite, are employed as anode materials. A suitable nonaqueous electrolyte comprising a lithium salt or salts and a blend of nonaqueous solvents is also employed. Such electrolytes must react favorably with lithium during the first lithiation of the anode in order to create a stable solid electrolyte interface (“SEI”) layer on the anode that allows for desirable subsequent ionic transport therethrough while preventing further reaction with the electrolyte. Further, suitable electrolytes desirably have numerous other characteristics including high ionic conductivity for lithium, high thermal and electrochemical stability at the cathode, and so on. Suitable solvents for commercial use typically contain ethylene carbonate in order to create the desired SEI layer and also are blended with other suitable nonaqueous solvents, including other carbonate solvents, to provide for other desirable properties. A variety of lithium salts or salt mixtures may find use in commercial products.

While present day Li-ion batteries generally perform well for a wide range of applications, it is still desirable to introduce improvements in such things as cell capacity and lifetime. However, while improving the former may be achieved for instance by employing high voltage cathode materials and/or operating batteries at higher voltages, such an approach generally adversely affects the latter. That is because higher voltages typically increase the rate of electrolyte decomposition. Such tradeoffs are generally encountered in the development of better battery products.

A common approach used to improve battery performance in one regard or another, without unacceptably affecting others involves the use of electrolyte additives. Certain additives or additive mixtures in principle can be used to enhance a desired battery characteristic or to reduce an undesirable characteristic. A great deal of research has been done over the years in this regard and numerous chemical species and combinations thereof have been identified and tested as possible suitable electrolyte additives.

For instance, US20180102570 discloses lithium secondary batteries comprising disulfonate additive and methods of preparing the same. In an embodiment, fluoro-ethylene carbonate (FEC), vinylene carbonate (VC), vinylethylene carbonate (VEC), a phosphine compound (e.g. triphenyl phosphine), a phosphite compound, a phosphate compound, propane sultone (PS), or a combination thereof may further be included in the nonaqueous solvent in the batteries. Further, electrolytes used in the Examples included MMDS and LiDFOB and LiFSI salts. Such electrolytes were found to lower the impedance increase over cycling, but did not lead to better lifetimes.

Further, WO2019025980 discloses a nonaqueous electrolyte for a lithium ion battery which includes a lithium salt, a first nonaqueous solvent, and an additive mixture comprising a first operative additive of lithium difluorophosphate and a second operative additive of either fluoro ethylene carbonate or vinylene carbonate. A lithium-ion battery includes a negative electrode, a positive electrode comprising NMC with micrometer-scale grains, a nonaqueous electrolyte having lithium ions dissolved in a first nonaqueous solvent, and an additive mixture having a first operative additive of either fluoro ethylene carbonate or vinylene carbonate and a second operative additive of either 1,3,2-dioxathiolane-2,2-dioxide, another sulfur-containing additive, or lithium difluorophosphate.

Further still, WO2018198742 discloses a lithium ion secondary battery including a positive electrode including a positive electrode active material containing a lithium nickel complex oxide, a cyclic sulfonic acid ester which contains at least two sulfonyl groups in a molecule and a compound which contains only one sulfonyl group in a molecule and of which an energy level of a highest occupied molecular orbital calculated by a PM3 method is −11.2 eV or less are used in an electrolyte. In addition, by charging such a battery, a film including a sulfur atom is formed on at least a portion of a surface of the positive electrode active material.

Yet further, the disclosure of US20170301952 relates to an electrolyte and a lithium-ion battery containing the electrolyte. The electrolyte here comprises a lithium salt, an organic solvent and additives that include additive A, additive B and at least one of additive C and additive D; in which, the additive A is a cyclic sultone; the additive B is a cyclic sulfate; the additive C is a silane phosphate compound and/or a silane borate compound; and the additive D is a fluoro-phosphate salt. The battery has low gas production at high temperature, high capacity retention rate and high power at low temperature as a function of synergistic effects of additives.

It is generally known in the art that addition of a small quantity of MA additive is a way to increase charge rate and low temp performance. Such additives are disclosed for instance in U.S. Pat. No. 6,492,064 which relates to organic solvents, electrolytes, and lithium ion cells with good low temperature performance. But MA is very reactive at high voltage and decreases lifetime performance due to the high reactivity. Therefore it requires further additives to make it work. Further it is generally known in the art that addition of very small quantities of sulfur additives helps battery performance at high voltages. In particular, sulfur additives like DTD have shown to improve performance when MA is present as disclosed in US20190036171 for instance.

It is also generally known and accepted in the art that the solvents VC and FEC are essentially interchangeable functionally in lithium secondary battery applications. This is illustrated for instance in WO2019025980 which discloses a nonaqueous electrolyte for a lithium ion battery which includes a lithium salt, a first nonaqueous solvent, and an additive mixture comprising a first operative additive of lithium difluorophosphate and a second operative additive of either fluoro ethylene carbonate or vinylene carbonate. A lithium-ion battery includes a negative electrode, a positive electrode comprising NMC with micrometer-scale grains, a nonaqueous electrolyte having lithium ions dissolved in a first nonaqueous solvent, and an additive mixture having a first operative additive of either fluoro ethylene carbonate or vinylene carbonate and a second operative additive of either 1,3,2-dioxathiolane-2,2-dioxide, another sulfur-containing additive, or lithium difluorophosphate. In particular, examples in WO2019025980 involve the use of VC or FEC and from these it is apparent that they are basically interchangeable in the results obtained.

Despite the continuing and substantial global effort directed at improving rechargeable batteries, further improvements are still desired in all areas. The present disclosure addresses these needs and provides further benefits as disclosed below.

### SUMMARY

Electrolytes comprising certain specific additive mixtures have been found to result in improved performance in nonaqueous batteries and particularly in rechargeable lithium ion batteries and more particularly in improved lifetime in high voltage, rechargeable lithium ion batteries (e.g. such as those whose maximum operating voltage limit is 4.2 V or greater).

Specifically, the nonaqueous battery electrolyte of embodiments herein comprises a primary lithium salt, a primary nonaqueous solvent, and less than 10% by weight of an additive mixture. The additive mixture is characterized in that it comprises: an additive solvent selected from the group consisting of vinylene carbonate and fluoroethylene carbonate, a sulfur containing compound selected from the group consisting of methylene methane disulfonate and ethylene sulfate, and lithium difluorophosphate.

The primary solvent in the electrolyte can comprise at least one solvent selected from the group consisting of ethylene carbonate, ethyl methyl carbonate, fluoroethylene carbonate, dimethyl carbonate, propylene carbonate, diethyl carbonate, and methyl acetate. The primary lithium salt in the electrolyte can comprise at least one salt selected from the group consisting of LiPF₆, LiBF₄, lithium bis(oxalate) borate, and lithium difluoro(oxalato)borate.

In one embodiment, the primary solvent comprises ethylene carbonate, ethyl methyl carbonate, and dimethyl carbonate. Further, in one embodiment, the primary lithium salt is LiPF₆. Further still, in certain embodiments, the primary nonaqueous solvent is different from the additive solvent and the primary lithium salt is different from lithium difluorophosphate.

Most generally, the electrolyte comprises less than 10% by weight of the additive mixture. In that, typically the electrolyte comprises between 0.1% and 5% by weight of the additive solvent, between 0.1% and 3% by weight of the sulfur containing compound, and between 0.1% and 5% by weight of lithium difluorophosphate. The electrolyte may further comprise between 0% and 2% by weight of a sultone compound, such as 1,3-propene sultone.

The improved nonaqueous battery electrolyte is particularly advantageous for use in a high voltage, rechargeable, lithium ion battery which additionally comprises a cathode electrode and an anode electrode along with the inventive nonaqueous battery electrolyte. In this regard, a representative high voltage, rechargeable lithium ion battery is one in which the cathode electrode comprises a compound with the formula LiₓM_{y}O_{z} where 0≤x, y≤2, 2≤z≤4, and M comprises of one or more of the following elements: Ni, Al, Mn, Co, Fe, P, Mg, Ti, Zr, Ga, Cr, Ru, such as a lithium nickel manganese cobalt oxide with a stoichiometry of about LiNi_{0.6}Mn_{0.2}Co_{0.2}O₂. Such cathode electrodes may also optionally include a surface coating. Further, in this regard, a representative high voltage, rechargeable lithium ion battery is one in which the anode electrode comprises graphite.

The disclosure herein thus also includes methods of improving cycle life and stability of a high voltage, rechargeable, lithium ion battery. A relevant battery in this regard comprises a cathode electrode, an anode electrode, and a nonaqueous electrolyte in which the electrolyte comprises a primary lithium salt, and a primary nonaqueous solvent. The method then comprises incorporating less than 10% by weight of the aforementioned additive mixture into the electrolyte.

### BRIEF DESCRIPTION OF THE DRAWINGS

FIG. 1 shows normalized capacity versus cycle number of representative cells during the LTC testing of Experiment 1 in the Examples.

FIG. 2 shows Delta V versus cycle number of representative cells during the LTC testing of Experiment 1 in the Examples.

FIGS. 3a and 3b show normalized capacity versus cycle number of representative cells without LFO and cells with LFO in their electrolyte respectively during the LTC testing of Experiment 1 in the Examples.

FIGS. 4a and 4b show Delta V versus cycle number of representative cells without LFO and cells with LFO in their electrolyte respectively during the LTC testing of Experiment 1 in the Examples.

FIG. 5 shows storage testing results for representative cells in the Examples.

### DETAILED DESCRIPTION

Unless the context requires otherwise, throughout this specification and claims, the words “comprise”, “comprising” and the like are to be construed in an open, inclusive sense. The words “a”, “an”, and the like are to be considered as meaning at least one and are not limited to just one.

In addition, the following definitions are to be applied throughout the specification:

The term “lithium ion battery” refers to both an individual lithium ion cell or to an array of such cells that are interconnected in a series and/or parallel arrangement. Each such cell comprises anode and cathode electrode materials in which lithium ions can be reversibly inserted and removed.

The term “anode” refers to the electrode at which oxidation occurs when an alkali metal ion battery is discharged. In a lithium ion battery, the anode is the electrode that is delithiated during discharge and lithiated during charge.

The term “cathode” refers to the electrode at which reduction occurs when an alkali metal ion battery is discharged. In a lithium ion battery, the cathode is the electrode that is lithiated during discharge and delithiated during charge.

In a quantitative context, the term “about” should be construed as being in the range up to plus 10% and down to minus 10%.

In the present disclosure, certain additive mixtures have been identified that are advantageous for use in electrolytes for nonaqueous battery electrolytes comprising at least one (a primary) lithium salt and at least one (a primary) nonaqueous solvent. Additive mixtures are used in amounts of less than 10% by weight in such electrolytes and these are particularly suitable for use in rechargeable lithium batteries, e.g. high voltage, rechargeable, lithium ion batteries. Advantages in lifetime can be obtained, particularly with regards to cycle life and stability. The additive mixtures are characterized in that they comprise an additive solvent selected from the group consisting of vinylene carbonate and fluoroethylene carbonate, a sulfur containing compound selected from the group consisting of methylene methane disulfonate and ethylene sulfate, and lithium difluorophosphate.

In a representative embodiment, the primary solvent in the electrolyte is one of ethylene carbonate, ethyl methyl carbonate, fluoroethylene carbonate, dimethyl carbonate, propylene carbonate, diethyl carbonate, or methyl acetate. Commonly however, the electrolyte comprises a blend of more than one of these and/or other solvents. In exemplary embodiments appearing in the following Examples, the electrolyte comprises a blend of ethylene carbonate, ethyl methyl carbonate, and dimethyl carbonate. The primary lithium salt in the electrolyte is one of LiPF₆, LiBF₄, lithium bis(oxalate) borate, or lithium difluoro(oxalato)borate. In exemplary embodiments appearing in the following Examples, the electrolyte comprises LiPF₆ salt. Again though, the electrolyte may comprise more than one such salt.

Suitable additive mixtures for use in the inventive electrolyte comprise vinylene carbonate and/or fluoroethylene carbonate. For clarity, the primary nonaqueous solvent in the electrolyte is different from the additive solvent and thus is not vinylene carbonate nor fluoroethylene carbonate. Further, for clarity again, the primary lithium salt is different from lithium difluorophosphate.

While the aforementioned components in the present additive mixtures may have been suggested for use in the prior art, either singly or in smaller subcombinations, the use of each results in certain undesirable drawbacks or disadvantages. We have found however that the present selection of components unexpectedly provides for performance advantages, without the unacceptable tradeoffs found with prior art additive mixtures.

In particular, embodiments in which the electrolyte comprises between 0.1% and 5% by weight of the additive solvent, between 0.1% and 3% by weight of the sulfur containing compound, and between 0.1% and 5% by weight of lithium difluorophosphate can provide for the benefits of certain embodiments. Further still, the additive mixture may optionally contain a sultone compound (e.g. 1,3-propene sultone) in amounts between 0% and 2% by weight in order to obtain additional beneficial results.

There are numerous choices available these days for the components that may be used in rechargeable batteries generally and specifically in lithium ion batteries and these are well known to those of ordinary skill in the art. Further, there are numerous constructions or designs available for such batteries (including coin, cylindrical, and prismatic embodiments) along with methods of fabrication which are well known to those in the art. Based on the present disclosure and the following Examples, it is expected that those skilled in the art will also readily be able to make an appropriate selection for the types and amounts of the components to be used in an inventive additive mixture to suit a given application in such nonaqueous rechargeable batteries.

Electrolytes of this disclosure have been demonstrated to provide superior performance advantages in rechargeable lithium ion batteries. Generally, such batteries comprise a cathode electrode, an anode electrode, and a nonaqueous battery electrolyte in which the electrodes are both lithium insertion compounds and the electrolyte comprises a nonaqueous electrolyte as described generally above. Typical cathode electrode materials comprise one or more compounds with the formula LiₓM_{y}O_{z} where 0≤x, y≤2, 2≤z≤4, and M comprises of one or more of the following elements: Ni, Al, Mn, Co, Fe, P, Mg, Ti, Zr, Ga, Cr, Ru. Optionally, these cathode materials may also have surface coatings applied thereto in order to obtain functional benefits known to those in the art. Typical anode electrode materials comprise carbonaceous compounds, preferably graphite but also cokes and disordered carbons.

In particular though, electrolytes of this disclosure have specifically been demonstrated to address problems encountered when high voltage cathodes are employed in such batteries (e.g. cathodes comprising nickel containing lithium transition metal oxide materials such as lithium nickel manganese cobalt oxide materials having a stoichiometry of about LiNi_{0.6}Mn_{0.2}Co_{0.2}O₂). Such batteries typically are characterized by maximum operating voltage limits of 4.2 V or greater. Use of additive mixtures of the present disclosure thus represent a method for improving lifetime, and specifically for improving cycle life and stability of such high voltage, rechargeable, lithium ion batteries.

It has been found experimentally that the present selection of components in additive mixtures of embodiments herein unexpectedly provides for such possible improvements without significant or unacceptable adverse effects on other performance aspects in rechargeable lithium batteries. This has clearly been demonstrated in the Examples below for additive mixtures comprising VC. And as is well known to those skilled in the art, FEC is not only chemically similar to VC but also has been shown to perform similarly to VC in other prior art embodiments. Hence, it would be expected that FEC could substitute for VC in the present disclosure.

The following examples are illustrative of certain aspects of the invention but should not be construed as limiting the invention in any way. Those skilled in the art will readily appreciate that batteries other than high voltage, rechargeable lithium ion batteries may also enjoy certain benefits from use of the electrolytes in embodiments disclosed herein.

### EXAMPLES

Preparatory and Analytical Methods

Several series of experimental lithium ion batteries were made and tested using a variety of electrolytes to determine and compare the performance results obtained with electrolytes of the present disclosure and otherwise conventional or prior art electrolytes. In all cases, the batteries used were individual pouch cells made in-house in a pilot production facility using commercial materials. The cathode electrodes were made with single-crystal “NMC622”, a lithium nickel manganese cobalt oxide having a stoichiometry of about LiNi_{0.6}Mn_{0.2}Co_{0.2}O₂(EASpring ME6SC) which was coated on aluminum foil substrates at a loading of 19.4±0.4 mg cm⁻² and compressed to a density of 3.3±0.1 g cm⁻³. The anode electrodes were made with artificial graphite (Kaijin AML400) which was coated on copper foil substrates at a loading of 12.4±0.3 mg cm⁻² and compressed to a density of 1.55±0.03 g cm⁻³. These cells were built with a nominal capacity of −300 mAh balanced to 4.4 V operation with an anode:cathode capacity ratio of 1.08.

Test electrolytes were blended in-house in an argon filled glovebox (MBraun). The electrolytes in all cells contained 1.2 M LiPF₆ (Soulbrain) in a solvent blend (Capchem) consisting of ethylene carbonate (“EC”), ethyl methyl carbonate (“EMC”), and dimethyl carbonate (“DMC”) in a mass ratio of 25 wt. % EC:5 wt. % EMC:70 wt. % DMC (henceforth referred to as “25EC:5EMC:70DMC”). Additive mixtures were added thereto according to weight percent of the total electrolyte and included vinylene carbonate (“VC”, Capchem), methylene methane disulfonate (“MMDS”, TCI Chemicals), ethylene sulfate, also known as 1,3,2-Dioxathiolane 2,2-dioxide, (“DTD”, Capchem), and lithium difluorophosphate (“LFO”, Capchem). Herein, cells will be denoted according to short hand names describing the weight percentage of the additive components in the specific cell (e.g. “2VC 1MMDS” refers to a test cell using 1.2M LiPF₆ 25EC:5EMC:70DMC electrolyte which includes an additive mixture of 2% wt. VC and 1% wt. MMDS). In some cases, certain test cells contained a solvent blend including methyl acetate (“MA”, Capchem) in a mass ratio of 20MA:80(25EC:5EMC:70DMC). Such cells include “20MA” in their short-hand name (e.g. “2VC1 MMDS 20MA”). Further, in some cases, certain test cells contained amounts of less than 1% of an additive component. In these cases, “05MMDS” indicates 0.5% by wt. MMDS, “05DTD” indicates 0.5% by wt. DTD, etc.

Cells were dried in a vacuum oven overnight at 90° C. before filling with electrolyte. Cells were then filled in a dryroom (<−55° C. dewpoint) with 1.20±0.05 g electrolyte using a pipette, and then placed under vacuum for 30 seconds at −90 kPa to remove air trapped in the electrode stack and to wet the electrodes. Cells were then transferred into a vacuum sealer (MSK-115, MTI Corporation) and sealed for 5 seconds at 165° C.

The mass of each cell while suspended underwater was then measured using a precision digital balance with a bottom mounted hook. The open circuit voltage (“OCV”) and alternating current impedance (“ACR”, 1 kHz+/−0.2 Hz at 10 mA (<300 mOhm) or 1 mA (<3 Ohm)) were also measured using a Hioki 3561 HiTester (Hioki).

Mechanical pressure of about 20-30 psi was then applied to each cell by clamping each between the surface of a metal plate and a metal shim using a toggle clamp mounted to the plate.

Cells then underwent a conditioning protocol in a 40.0±0.1° C. test chamber while connected to a Novonix 2A5V High Precision Charging system (Novonix), or a Neware BTS 4000 tester (Neware). The conditioning protocol consisted of the following steps in sequence: 24 hour constant voltage (“CV”) hold at 1.5 V, C/20 charge to 4.3 V, C/20 discharge to 2.8 V, C/20 charge to 4.3 V, 48 hour OCV, and C/20 discharge to 3.8 V. [As per conventional use, herein C/20 refers to the rate of charge and discharge which corresponds to obtaining the full nominal capacity of the cell over 20 h.]

After conditioning, the mass of each cell suspended under water, their OCV and ACR were again measured. The difference in mass suspended under water before and after conditioning is equal to the volume change of the cell based on the Archimedes principle, and is reported below as the gas volume produced during conditioning. Cells were then cut open in the dry room to release this gas produced during conditioning and were once again re-sealed using the same sealing procedure described above. Cells were then weighed yet again underwater for gas volume calculations to be obtained after cycling tests. Cells were then re-clamped as above and underwent various electrochemical tests as described in detail below. These electrochemical tests included Long-term cycling (“LTC”), High Precision Coulometry (“HPC”), Rate Test Cycling (“RTC”), and Storage Testing (“ST”).

Long-Term Cycling:

Cells for LTC testing were placed in a temperature chamber at 40.0±0.1° C. and connected to a Neware BTS4000 cycler. Cells underwent a protocol comprising the following steps:
1. C/20 Charge to 4.3 V
2. C/20 Discharge to 2.8 V
3. C/20 Charge to 4.3 V
4. C/20 Discharge to 2.8 V
5. C/5 Charge to 4.3 V with constant voltage (CV) hold at 4.3 V until current reaches C/20
6. C/2 Discharge to 2.8 V
7. Repeat Steps 5-7 (50 times)
8. C/5 Charge to 4.3 V with CV hold at 4.3 V until current reaches C/20
9. Return to Step 2 (until experiment ends)

High Precision Coulometry:

Cells for HPC testing were placed in a temperature chamber at 40.0±0.1° C. and connected to a Novonix 5V2A High Precision Charger. Cells underwent a protocol comprising the following steps:
1. C/10 Discharge to 2.8 V
2. C/10 Charge to 4.3 V
3. C/10 Discharge to 2.8 V
4. Repeat from Step 2 (24 times)

Rate Test Cycling:

Cells for RTC testing were placed on a shelf at 21.5±0.5° C. and connected to a Neware BTS4000 cycler. Cells underwent a protocol comprising the following steps:
1. C/20 Charge to 4.3 V
2. C/20 Discharge to 2.8 V
3. C/20 Charge to 4.3 V
4. C/20 Discharge to 2.8 V
5. C/2 Charge to 4.3 V with CV hold at 4.3 V until current reaches C/20
6. C/2 Discharge
7. Repeat Steps 5-6 (10 times)
8. Repeat Steps 1-4
9. 1C Charge to 4.3 V with CV hold at 4.3 V until current reaches C/20
10. 1C Discharge
11. Repeat Steps 9-10 (10 times)
12. Repeat Steps 1-4
13. 2C Charge to 4.3 V with CV hold at 4.3 V until current reaches C/20
14. 2C Discharge
15. Repeat Steps 13-14 (10 times)
16. Repeat Steps 1-4
17. 3C Charge to 4.3 V with CV hold at 4.3 V until current reaches C/20
18. 3C Discharge
19. Repeat Steps 17-18 (10 times)
20. Repeat Steps 1-4

Storage Testing:

Cells for ST testing were placed in a temperature chamber at 40.0±0.1° C. and connected to a Novonix 5V2A High Precision Charger. Cells underwent a protocol comprising the following steps:
1. C/20 Charge to 4.3 V
2. C/20 Discharge to 2.8 V
3. C/20 Charge to 4.3 V
4. CV at 4.3 V for 12 hours
5. Transfer cells immediately into a 60.0±0.1° C. temperature chamber
6. let sit at OCV for 500 hours

### Experiment 1

Performance of Incremental Additive Mixtures

Cells were made and tested with various electrolytes including electrolyte with no additives (i.e. 25EC:5EMC:70DMC), 2VC, 2VC 1LFO, 2VC 1MMDS, and 2VC 1MMDS 1LFO electrolytes. Additionally, cells were made with 2VC 1LFO 20MA, 2VC 1MMDS 20MA, and 2VC 1MMDS 1LFO 20MA electrolytes and were tested. Cells underwent the defined conditioning protocol followed by HPC, LTC, and RTC tests.

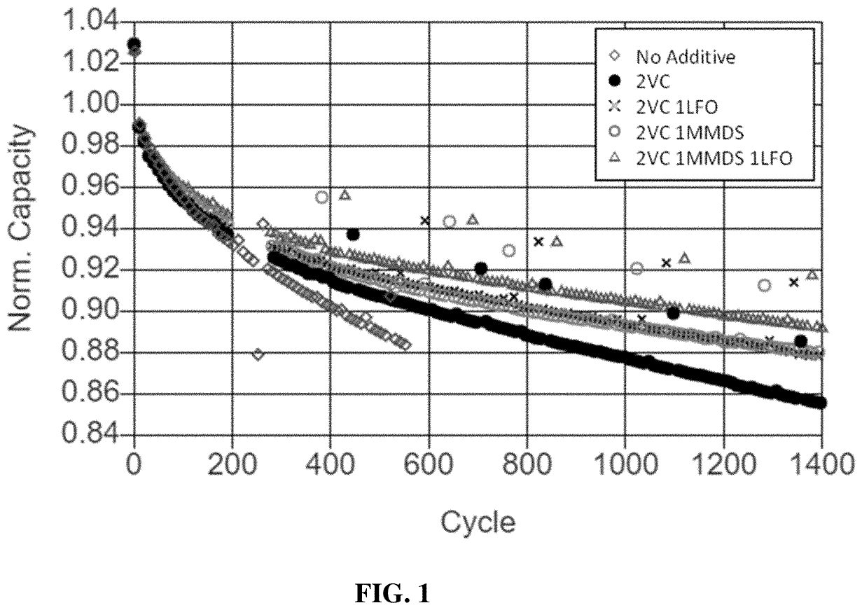

Table 1 shows the first cycle coulombic efficiency “FCCE” during conditioning (i.e. first discharge capacity divided by first charge capacity). A higher FCCE typically means a more robust solid electrolyte interface “SEI” layer has formed, resulting in fewer side reactions during the first cycle at the anode, cathode, or both. The results in FIG. 1 shows that the addition of each additive to the electrolyte produces a cumulative beneficial impact on FCCE. A higher FCCE also means that a cell will finish conditioning with more accessible capacity at the start of its useful life cycle. Use of 2VC 1MMDS 1LFO yields the highest FCCE of the additive mixtures, including when MA is added to the electrolyte, suggesting the ternary additive mixture protects the anode and cathode from parasitic reactions better than the binary combinations of 2VC 1MMDS and 2VC 1LFO.

The results in table 1 show that the addition of MMDS and LFO does not significantly affect the gas produced during conditioning compared to 2VC, and that the addition of MMDS in the 2VC 1MMDS 1LFO mixture suppresses excess gas produced in 2VC 1LFO.

Table 1 also shows the voltage drop during the 48 h OCV step during conditioning (Step 5). Reactions at the NMC cathode result in a cell voltage drop due to electrolyte oxidation reactions at high voltage (4.3 V). A smaller OCV drop is indicative of a lower degree of electrolyte oxidation due to more robust SEI layers on the anode and cathode. Some electrolyte oxidation can occur when reaction products from reactions at the anode migrate through the electrolyte causing crosstalk reactions. A decrease in OCV voltage drop can also suggest a more robust anode SEI has been formed. When VC is used, the voltage drop decreases significantly compared to that of cells with no additives. Table 1 results show that MMDS can further lower the voltage drop when paired with VC. However, the addition of LFO to VC or VC with MMDS results in the lowest voltage drop values. When paired with MA, 2VC 1MMDS 1LFO 20MA outperforms both 2VC 1MMDS 20MA and 2VC 1LFO 20MA, suggesting that the unique ternary combination creates more robust mitigation of parasitic reactions at the cathode compared to the other mixtures.

TABLE 1
Cell performance results for conditioning, HPC, and RTC tests in Experiment 1

| | Conditioning | | | | | | | |
|---|---|---|---|---|---|---|---|---|
| | | | Voltage | HPC metrics (Cycle 5 to 28) | | | RTC C/20 Capacity | |
| | | Gas | drop | | Slippage | Fade | After | After |
| Electrolyte | FCCE | (mF) | (V) | CE | (Ah) | (Ah) | 10× 2 C | 10× 3 C |
| No additive | 0.8733 | 2.720 | 0.0546 | 0.09983 | 0.00523 | 0.00746 | 97.9% | 96.3% |
| 2VC | 0.8788 | 0.494 | 0.0462 | 0.99907 | 0.00281 | 0.00801 | 98.1% | 95.4% |
| 2VC 1LFO | 0.8861 | 0.582 | 0.0421 | 0.99924 | 0.00238 | 0.00777 | 95.6% | 85.8% |
| 2VC 1MMDS | 0.8911 | 0.507 | 0.0443 | 0.99922 | 0.00252 | 0.00753 | 98.4% | 96.7% |
| 2VC 1MMDS | 0.8967 | 0.509 | 0.0422 | 0.99933 | 0.00134 | 0.00784 | 96.2% | 91.4% |
| 1LFO | | | | | | | | |
| 2VC 1MMDS | 0.8892 | 0.645 | 0.0474 | 0.99919 | 0.00268 | 0.00747 | 99.3% | 97.9% |
| 20MA | | | | | | | | |
| 2VC 1LFO | 0.8828 | 0.607 | 0.0472 | 0.99900 | 0.00314 | 0.00792 | 98.6% | 92.6% |
| 20MA | | | | | | | | |
| 2VC 1MMDS | 0.8963 | 0.569 | 0.0455 | 0.99919 | 0.00337 | 0.00710 | 98.6% | 94.3% |
| 1LFO 20MA | | | | | | | | |

Note:
results shown are averages taken of 2-3 cells made with identical batches of components. Slippage and Fade results are cumulative from cycle 5 to 28 due to a power interrupt at cycle 4.

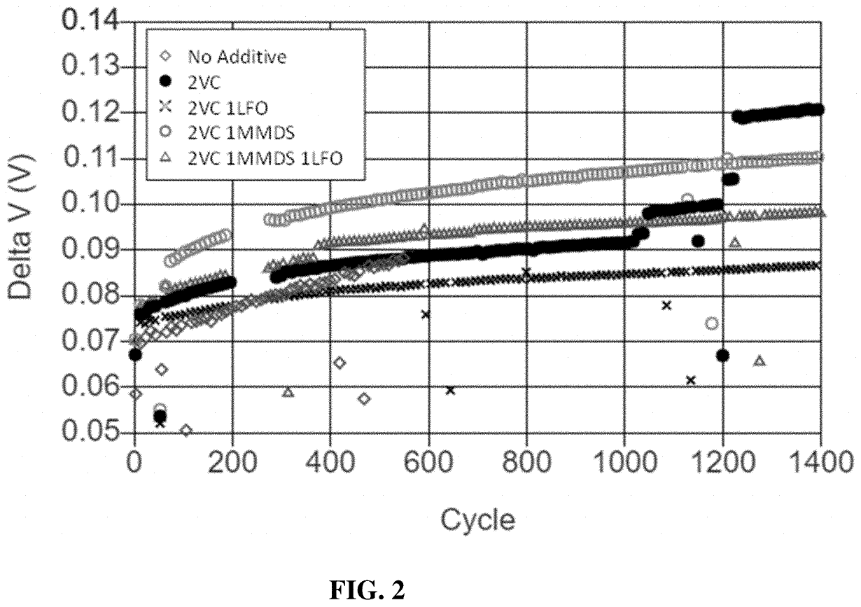

FIG. 1 and FIG. 2 show results of LTC testing for representative cells without MA in the additive mixture (i.e. no additive, 2VC, 2VC 1LFO, 2VC 1MMDS, and 2VC 1MMDS 1LFO) and illustrate the improvements seen in LTC when additives are incrementally added to the electrolyte. FIG. 1 plots normalized cell capacity and FIG. 2 plots Delta V versus cycle number. As shown in FIG. 1, with each additive component (VC, MMDS, LFO) added to the cells, the performance subsequently improved. The cell with 2VC 1MMDS 1LFO electrolyte had the best capacity retention, losing 10% capacity in approximately 1000 cycles compared to cells with 2VC 1MMDS and 2VC 1LFO which lost the same capacity in 800 cycles, and the cell with 2VC which lost the same capacity in 600 cycles, and the cell with no additive which lost the same capacity in 400 cycles. At the rate of fade of the last 500 cycles, the 2VC 1MMDS 1LFO cell would reach 80% capacity at approximately 4200 cycles. FIG. 2 shows the Delta V (average charge voltage−average discharge voltage) and represents the rate of impedance increase in the cells, where the slope is indicative of the rate of impedance increase. The cell with no additive had the largest rate of impedance increase, while the 2VC 1MMDS 1LFO and 2VC 1LFO cells had the slowest impedance increase. The results suggest that the cell with 2VC 1MMDS 1LFO will have a much longer lifetime than those with the other electrolytes due to the protective nature of the SEIs formed on the electrodes.

Table 1 also outlines the results of HPC tests after 28 charge discharge cycles. The Coulombic Efficiency “CE” indicates the discharge capacity divided by the previous charge capacity. The higher the CE, the more stable the cell chemistry is. The 2VC 1MMDS 1LFO cell had the highest CE, and had a higher CE than a 2VC 1LFO cell when MA is added to the cell. The cumulative charge endpoint capacity slippage (called “Slippage” in Table 1 and represents the extent to which the cumulative capacity changes after repeated cycling as a result of parasitic reactions and other losses) can indicate the stability of the cell towards electrolyte oxidation reactions. HPC slippage agrees with conditioning OCV results and LTC results, indicating a much lower amount of electrolyte oxidation reactions occur when 2VC 1MMDS 1LFO is used. Capacity “Fade” indicates the amount of capacity lost since the beginning of the HPC test (cycle 5 in Experiment 1). Differences in capacity fade were not as dramatic as slippage values in HPC tests. The 2VC 1MMDS 1LFO cell showed more capacity fade than the 2VC 1LFO and 2VC 1MMDS cells despite its higher CE and slippage results. This could be due to a more stable rate of slippage per cycle, which can change the rate of observed capacity fade, while not affecting the CE.

Table 1 also shows the summarized results from RTC tests. After each set of 10 cycles at C/2, 1C, 2C, and 3C CCCV-charge and CC-discharge cycling at room temperature, two C/20 CC cycles were performed. Table 1 shows the discharge capacity of the second C/20 cycle after the 2C rate test (Step 16) and 3C rate test (Step 20) normalized to the second C/20 cycle in the RTC test (Step 4). Any differences correspond to capacity lost due to active electrode material loss or lithium metal plating in the cell due to rate limitations of the materials, SEI, and electrolyte. Table 1 shows that the addition of 1LFO leads to worse rate performance when added to 2VC, whereas the addition of 1MMDS improves rate performance. When combined, the 2VC 1MMDS 1LFO cell achieved more rate capability than the 2VC 1LFO cell, especially after 3C cycling, maintaining 91.4% capacity over the course of the RTC protocol. When MA is added to the electrolyte, the 2VC 1MMDS 1LFO 20MA cell showed a similar compromise of the performance of cells with 2VC 1MMDS 20MA and 2VC 1MMDS 1LFO 20MA, maintaining 94.3% capacity over the course of the RTC protocol.

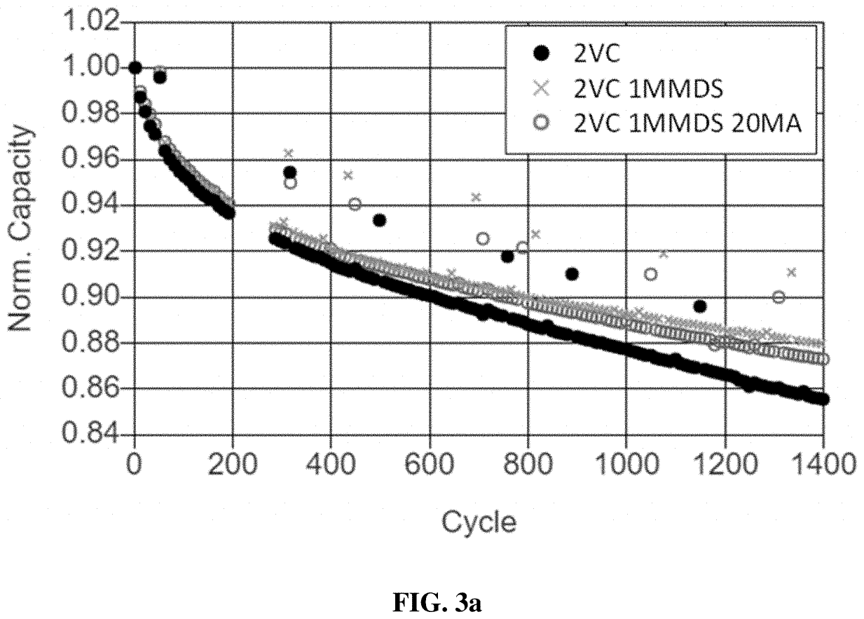

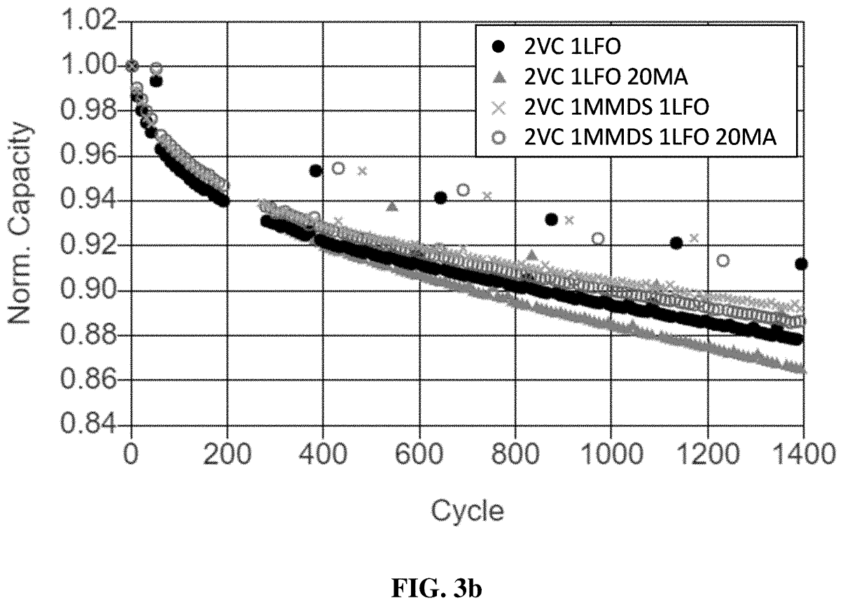

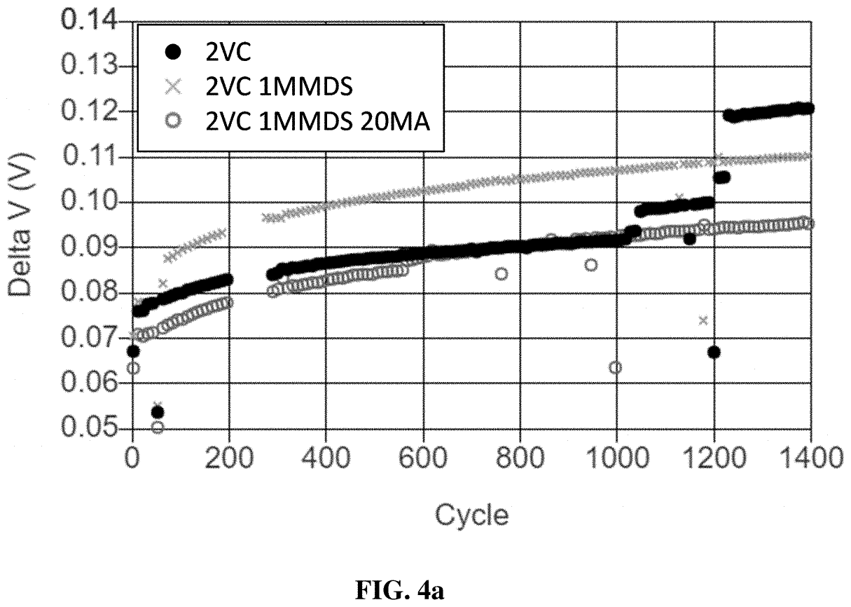

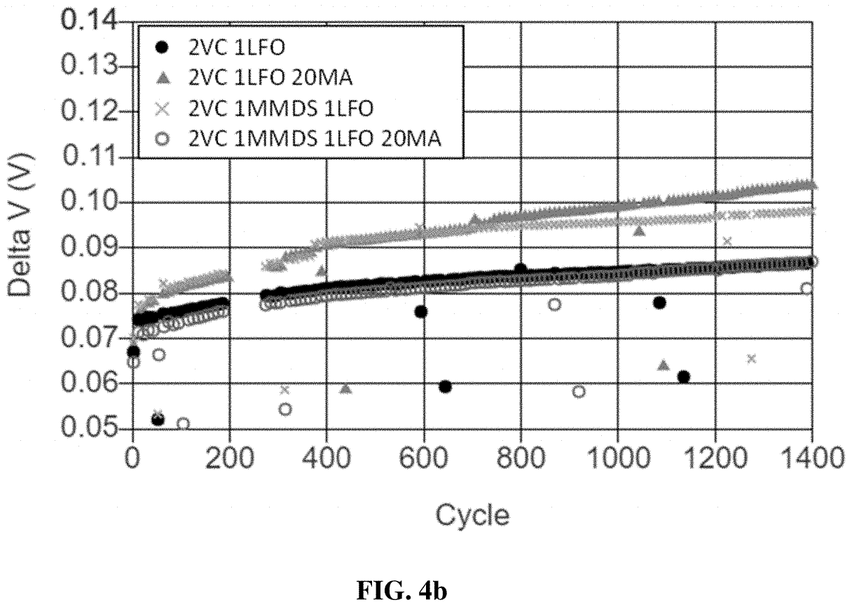

FIG. 3a shows the LTC capacity retention (nominal capacity versus cycle number) for cells having electrolytes without LFO, and FIG. 3b shows the capacity retention for cells having electrolytes with LFO, to highlight the effects of MA on long term cycling. FIGS. 4a and 4b plot Delta V for the same cell groupings respectively. FIG. 3a and FIG. 4a show that 2VC 1MMDS with 20MA additive mixture is effective at mitigating the impedance increase typically associated with the addition of MA during long-term, high voltage cycling. FIG. 3b and FIG. 4b show that the cell with 2VC 1LFO 20MA has more rapid capacity loss and increasing delta V (impedance increase), suggesting that MMDS is more effective than LFO at protecting the cathode against electrolyte oxidation. However, the cell with 2VC 1MMDS 1LFO 20MA had the best overall capacity retention and low impedance growth, demonstrating dramatic improvement over 2VC 1MMDS 20MA and especially 2VC 1LFO 20MA additive mixtures, further demonstrating the favorable synergy in the additive mixture of VC-MMDS-LFO.

### Experiment 2

Performance Comparison of Sulfur Containing Additives

In Experiment 2, testing similar to that done in Experiment 1 was performed on cells having similar electrolytes but with differing sulfur containing compounds in the additive mixtures. Here, cells containing 2VC, 2VC 1PS, 2VC 1PS 1LFO, 2VC 0.5MMDS, 2VC 0.5MMDS 1LFO, 2VC 1DTD, 2VC 1DTD 1LFO, 2VC 1PES, and 2VC 1PES 1LFO were made and tested. The results of these tests are summarized in Table 2.

Table 2 shows that all additive mixtures with PS, MMDS, DTD, and PES showed increased FCCE and decreased voltage drop in cells with the addition of LFO. The gas during conditioning increased with the addition of LFO in all cases except in the 2VC 1PES 1LFO cell, which had very low gas production during conditioning. The 2VC 1DTD 1LFO cell had a large amount of gas in conditioning. In Experiment 3 below, the effect of combining PES with MMDS and DTD to decrease gas production in conditioning is demonstrated.

Table 2 also shows that the 2VC 0.5MMDS 1LFO and 2VC 1DTD 1LFO cells had the highest CE in HPC tests with both low slippage and fade.

In the RTC tests, it was observed that cells with all additive mixtures without LFO performed well up to 3C cycling, and were able to deliver at least 94.2% (2VC 1PS) up to 97.3% (2VC 1DTD) of the original cell capacity at C/20 after 3C cycling. However, when LFO was added, the 2VC 1PS 1LFO and 2VC 1PES 1LFO cells lost significant capacity after 2C (88.1% and 74.2%, respectively) and 3C (75.5% and 65%, respectively) cycling. The 2VC 0.5MMDS 1LFO cell was able to deliver 96.6% and 91.1% after 2C and 3C cycling, respectively, while the 2VC 1DTD 1LFO cell delivered 96.4% and 91.3%. The dramatic improvement in rate performance shows further favorable, surprising synergy between VC, MMDS/DTD, and LFO.

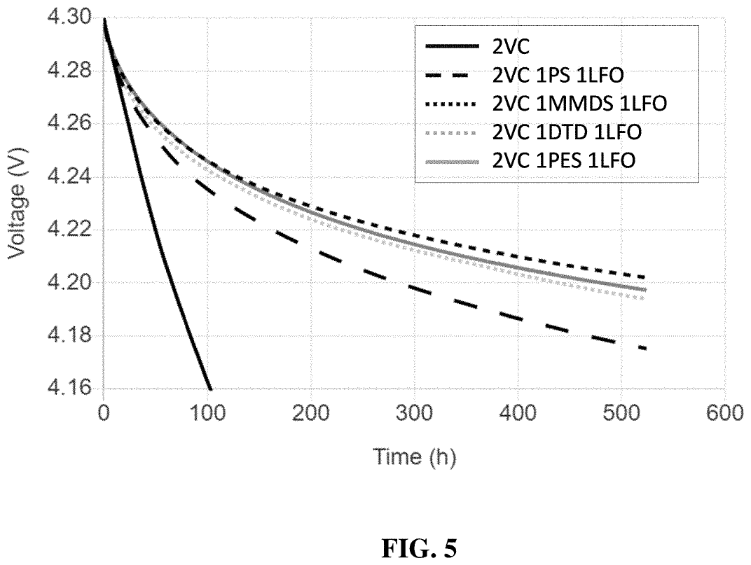

ST test results are shown in FIG. 5 for cells with 2VC, 2VC 1PS 1LFO, 2VC 1MMDS 1LFO, 2VC 1DTD 1LFO, and 2VC 1PES 1LFO electrolytes. The voltage drop during the 500 hour OCV, 60° C. test indicates stability of the cell towards electrolyte oxidation at the cathode. The benefits of sulfur containing additive components in the additive mixtures is apparent, as VC alone creates rapid voltage drop indicating a very high rate of reaction. Sulfur containing additives create a robust SEI at the cathode surface that protects against electrolyte oxidation. FIG. 5 also demonstrates that the 2VC 1MMDS 1LFO cell had the lowest voltage drop during high temperature storage tests, followed by the 2VC 1PES 1LFO and 2VC 1DTD 1LFO cells.

TABLE 2
Cell performance results for conditioning, HPC, and RTC tests in Experiment 2

| | Conditioning | | | HPC (cycle 1 to 24) | | | RTC Test C/20 Capacity | |
|---|---|---|---|---|---|---|---|---|
| | | Gas | Voltage | | Slippage | Fade | After | After |
| Electrolyte | FCCE | (mF) | Drop (V) | CE | (Ah) | (Ah) | 10× 2 C | 10× 3 C |
| 2VC | 0.8766 | 0.586 | 0.0469 | 0.99876 | 0.00365 | 0.00902 | 98.1% | 95.4% |
| 2VC IPS | 0.8914 | 0.304 | 0.0449 | 0.99888 | 0.00381 | 0.00797 | 97.2% | 94.2% |
| 2VC IPS 1LFO | 0.8965 | 0.332 | 0.0418 | 0.99902 | 0.00258 | 0.00825 | 88.1% | 75.5% |
| 2VC 0.5MMDS | 0.8863 | 0.498 | 0.0458 | 0.99886 | 0.00365 | 0.00823 | 98.3% | 96.8% |
| 2VC 0.5MMDS | 0.8938 | 0.551 | 0.0421 | 0.99909 | 0.00270 | 0.00796 | 96.6% | 91.1% |
| 1LFO | | | | | | | | |
| 2VC 1DTD | 0.8858 | 1.214 | 0.0487 | 0.99890 | 0.00314 | 0.00861 | 98.5% | 97.3% |
| 2VC 1DTD | 0.8915 | 1.429 | 0.0431 | 0.99906 | 0.00275 | 0.00811 | 96.4% | 91.3% |
| 1LFO | | | | | | | | |
| 2VC 1PES | 0.8902 | 0.362 | 0.0459 | 0.99902 | 0.00244 | 0.00773 | 97.0% | 94.6% |
| 2VC 1PES | 0.8944 | 0.250 | 0.0434 | 0.99890 | 0.00356 | 0.00777 | 74.2% | 65.0% |
| 1LFO | | | | | | | | |

Note:
results shown are averages taken of 2-3 cells made with identical batches of components. Slippage and Fade results are cumulative over cycles 1 to 24.

### Experiment 3

Gas Mitigation During Conditioning

In Experiment 3, PES was combined with DTD and MMDS-containing additive mixtures to reduce the amount of gas produced in cells during conditioning. Here, cells containing 1VC, 1VC 1PES 1LFO, 1VC 1MMDS 1LFO, 1VC 0.5MMDS 0.5PES 1LFO, 1VC 1DTD 1LFO, and 1VC 0.5DTD 0.5PES 1LFO were made and tested. The results of these tests are summarized in Table 3.

The results in Table 3 show that when 1MMDS is replaced with 0.5MMDS and 0.5PES in additive mixtures, a 48% gas reduction occurred. When 0.5PES 0.5DTD was used instead of 1DTD, a dramatic 72% reduction in gas occurred.

The substitution of PES into the VC-MMDS/DTD-LFO ternary additive mixture for MMDS or DTD lead to significant gas reduction during conditioning, as well as lower voltage drop and FCCE, suggesting similar or better HPC and LTC performance. However, based on the results obtained in Experiment 2, lower rate capability is expected. These tests were not performed in Experiment 3 however.

TABLE 3
Cell performance results for conditioning in Experiment 3

| | Conditioning | | |
|---|---|---|---|
| Electrolyte | FCCE | Gas (mL) | Voltage Drop (V) |
| 1 VC | 0.8834 | 0.818 | 0.0425 |
| 1 VC 1 PES 1 LFO | 0.9017 | 0.233 | 0.0385 |
| 1 VC 1 MMDS 1 LFO | 0.9034 | 0.572 | 0.0372 |
| 1 VC 0.5 PES 0.5 | 0.9050 | 0.296 | 0.0369 |
| MMDS 1 LFO | | | |
| 1 VC 1 DTD 1 LFO | 0.8920 | 1.724 | 0.0413 |
| 1 VC 0.5 PES 0.5 | 0.9037 | 0.486 | 0.0359 |
| DTD 1 LFO | | | |

Note:
results shown are averages taken of 2-3 cells made with identical batches of components.

All of the above U.S. patents, U.S. patent applications, foreign patents, foreign patent applications and non-patent publications referred to in this specification, are incorporated herein by reference in their entirety.

While particular elements, embodiments and applications of the present invention have been shown and described, it will be understood, of course, that the invention is not limited thereto since modifications may be made by those skilled in the art without departing from the spirit and scope of the present disclosure, particularly in light of the foregoing teachings. For instance, while the examples focused on additive mixtures comprising VC, it is expected that similar advantages may be obtained using fluoroethylene carbonate instead. Such modifications are to be considered within the purview and scope of the claims appended hereto.

1. A nonaqueous battery electrolyte, comprising:
a primary lithium salt, a primary nonaqueous solvent, and less than 10% by weight of an additive mixture, characterized in that the additive mixture comprises:
an additive solvent including vinylene carbonate (“VC”);
a sulfur containing compound including methylene methane disulfonate (“MMDS”); and
lithium difluorophosphate (“LFO”);
wherein the electrolyte comprises between 0.1% and 5% by weight of the additive solvent;
wherein the electrolyte comprises between 0.1% and 3% by weight of the sulfur containing compound;
wherein the electrolyte comprises between 0.1% and 5% by weight of lithium difluorophosphate.

2. The electrolyte of claim 1 wherein the primary lithium salt comprises at least one salt selected from the group consisting of: LiPF₆, LiBF₄, lithium bis(oxalate) borate, and lithium difluoro(oxalato) borate.

3. The electrolyte of claim 2 wherein the primary lithium salt is LiPF₆.

4. The electrolyte of claim 1 wherein the primary lithium salt is different from lithium difluorophosphate.

5. The electrolyte of claim 1 further comprising a sultone.

6. The electrolyte of claim 1, wherein the sulfur containing compound is MMDS.

7. The electrolyte of claim 1, wherein the primary nonaqueous solvent comprises ethylene carbonate (“EC”), ethyl methyl carbonate (“EMC”), and dimethyl carbonate (“DMC”) in a mass ratio of 25 wt. % EC:5 wt. % EMC:70 wt. % DMC.

8. The electrolyte of claim 1, wherein the sulfur containing compound includes ethylene sulfate (“DTD”).

9. A high voltage, rechargeable, lithium ion battery comprising a cathode electrode, an anode electrode, and the nonaqueous battery electrolyte of claim 1.

10. The lithium ion battery of claim 9, wherein the cathode electrode comprises a compound with the formula LiₓM_{y}O_{z} where 0≤x, y≤2, 2≤z≤4, and M comprises of one or more of the following elements: Ni, Al, Mn, Co, Fe, P, Mg, Ti, Zr, Ga, Cr, Ru.

11. The lithium ion battery of claim 10, wherein the cathode electrode a lithium nickel manganese cobalt oxide with a stoichiometry of about LiNi_{0.6}Mn_{0.2}Co_{0.2}O₂.

12. The lithium ion battery of claim 9, wherein the maximum operating voltage limit of the battery is 4.2 V or greater.

13. The lithium ion battery of claim 9, wherein the anode electrode comprises graphite.

14. A method of improving cycle life and stability of a high voltage, rechargeable, lithium ion battery comprising a cathode electrode, an anode electrode, and a nonaqueous electrolyte, the electrolyte comprising a primary lithium salt, a primary nonaqueous solvent, the method comprising incorporating less than 10% by weight of an additive mixture into the electrolyte wherein the additive mixture comprises:
an additive solvent including vinylene carbonate (“VC”);
a sulfur containing compound including methylene methane disulfonate (“MMDS”); and
lithium difluorophosphate (“LFO”);
wherein the electrolyte comprises between 0.1% and 5% by weight of the additive solvent;
wherein the electrolyte comprises between 0.1% and 3% by weight of the sulfur containing compound;
wherein the electrolyte comprises between 0.1% and 5% by weight of lithium difluorophosphate.

15. The method of claim 14, wherein the sulfur containing compound is MMDS.

16. The method of claim 14, wherein the primary lithium salt is LiPF₆.

17. The method of claim 14, wherein the additive mixture comprises 1 wt % VC, 1 wt % MMDS, and 1 wt % LFO.

18. The method of claim 14, further comprising a sultone.

19. The method of claim 14, wherein the additive mixture comprises 2 wt % VC, 0.5 wt % MMDS, and 1 wt % LFO.

20. The method of claim 14, wherein the primary nonaqueous solvent comprises ethylene carbonate (“EC”), ethyl methyl carbonate (“EMC”), and dimethyl carbonate (“DMC”) in a mass ratio of 25 wt. % EC:5 wt. % EMC:70 wt. % DMC.

21. The method of claim 14, wherein the sulfur containing compound includes ethylene sulfate (“DTD”).
